(19) United States
(12) Patent Application Publication
(10) Pub. No.: US 2006/0177094 A1
(43) Pub. Date: Aug. 10, 2006

(54) A SYSTEM FOR EMBEDDING, EXTRACTING, AND EXECUTING SELF-GOVERNING BEHAVIOR AND USE CONTROLS WITHIN DIGITAL MEDIUM CONTENT

(75) Inventor: Robert E. Smith, Missoula, MT (US)

Correspondence Address: ROBERT E. SMITH, P.O. BOX 4514, MISSOULA, MT, 59806, US

(73) Assignees: Mr. Robert E. Smith, Missoula, MT (US); NETWORK DATA SECURITY, Missoula, MT (US)

(21) Appl. No.: 10/905,820

(22) Filed: Jan. 21, 2005

(51) Int. Cl. G06Q 99/00; G06K 9/00

(52) U.S. Cl. 382/100; 705/1

(57) ABSTRACT

Steganography is the art of hiding information within information. The hidden information is called “covert” and the carrier information is called “overt.” In the digital world, steganography as a security technique differs considerably from encryption, watermarking, or placing data within digital envelopes. This invention uses steganographic techniques to embedded hidden behaviors, controls, and security within content creating self-governance of the content itself. The hidden behaviors include who, what, when, where, and how content is to be used. The hidden controls govern what can be done with the content such as copied, stored, deleted, and archived. The hidden embedded security includes authentication of author, source, and user of the content. In effect, the content becomes “smart content” and does not require network-centric security controls allowing ubiquitous exchanges across enterprises. This invention renders content counterfeit resistant, one-of-a-kind and includes self-editing schema for multimedia applications.

This invention creates “smart” content for digital medium that contains defined behavior knowledge sets concerning its use and origin; and executes these behaviors without network enforcements, interactions, or interpretations. The content itself carries its own governance of use. Unique to this invention is hiding embedded behaviors in content without using digital envelopes to encapsulate the content or by using object link embedding (OLE) to execute. Also, the steganographics for this invention do not depend upon watermark interpretation for ownership validation. Instead ownership, authorship and digital medium's source are automatically extracted from logically manipulated staganographic tables. These tables are deciphered when the user inputs the content's identifier (serial number). In addition, the digital medium may also extract an electronic witness providing automatic electronic notary. When applied to multimedia, a variation of the system allows the behavior's to execute a self-editing routine based upon behavior parameters and embedded editing meta tags. The use of the term “embedding” includes hiding data elements within content itself.

Behaviors may include, but are not limited to, any of the following: who, when, where, what, and how the medium's content may be used. “Who” defines users that are allowed to view, edit, sign, or modify the content. “What” defines specific content elements that can be viewed, copied, stored, or modified by the user. “When” defines the time elements used for viewing, deploying, archiving, or destroying the content. “Where” refers to where the content can be viewed, modified, or signed such as the location at which users can interact with the medium. This may include a specific network address or geopositioning coordinates at which content behaviors may be executed. “How” defines how the digital medium can be used such as the required sequence in obtaining electronic signatures from several users. In addition, “how” also refers to the method of archiving or storing the medium's content. Digital medium behaviors may be structured for use as table driven options that include prior art forms or newly define methodologies.

By using the art of steganography to hide (embed) behaviors within the digital content, the medium has greater security against alteration, misuse, or maliciousness intent and assures against embedded viruses.

“Smart” content for digital medium described herein forms self-contained knowledge of the content's own governance process; keeping the control behaviors within context of the content and also forms content-centric security absent of encryption key exchanges and is void of network-centric controls.

### BACKGROUND OF THE INVENTION

As more content is developed for diverse digital mediums, there becomes a greater requirement for increased controls to determine how content is used, who uses it, how it is modified, how it is signed, how the content is archived, and in affirming its source. Managing one or more of these governing elements, along with administration of user trust levels, creates a massive burden that is impractical for today's centralized control or network-centric approaches. For this reason, this invention creates content-centric behavior controls that are embedded hidden elements and can be applied to all digital mediums.

It is important to note that the content is NOT placed within a digital envelope that governs it use, but is hidden in the content data itself using unique extension to steganography techniques. By hiding embedded content behaviors, controls, and security within the content itself the content becomes a self-sufficient carrier of its own governance. The content's governance is independent of central controls, interpretations, or authorizations; regardless of where and how it is exchanged. This invention achieves this using a combination of logic tables, encryption, and array structuring within steganography techniques.

### PRIOR ART AND METHODOLOGIES

The basis of this invention is steganography with a new system and methodology for application creation. Steganography is the art of hiding information within information. The hidden information is called “covert” and the carrier information is called “overt.” In the digital world, “steganography”, as a security technique, differs considerably from encryption, watermarking, or placing data within digital envelopes, or embedding object links into content. Steganography actually steals bits of data from the carrier information in order to build a hidden message or meaning. For instants, steganorgraphic architecture may steal data bits from ASCII and color tables and structure the stolen bits into a hidden text message; using the same ASCII code for interpretation of the covert message. Or, least significant bits might be collected from image color tables and used to structure a text-base covert message within the image.

Encryption does not hide data within data but creates a code for scattering and reconstructing the data. Watermarks, on the other hand, structures symbols and codes by binding layers of data together in a manner that provides a unique pattern display. Although steganography has been used in watermarking, its use is limited to static bit pattern that require outside interpretation in order to authenticate the data source or ownership. Object embedded linking (OLE) can embed links that externally apply behaviors but the behaviors are separate from the medium's content, and therefore are often used out of context. Digital envelopes are used to encapsulate digital content for the purpose of securing the data or changing its protocols between applications while maintaining the original context of the data. Each of these application methods serves specific roles; to hide data, to hold data within its original context, or to authenticate data to its source.

The weakness of steganography are the algorithms used for embedding data; they work much like compression algorithms and once the algorithm is broken the hidden data can be compromised. This invention overcomes this weakness by using sets of logic that is not derived from mathematical manipulations and therefore falls outside the ability of today's stegoanalysis software packages. This invention assures original, one-of-a-kind, content with self-governance.

### DEFINITION OF DIGITAL MEDIUM

The term “digital medium” refers to any digital data or bit patterns (random or structured), and any electromagnetic emissions relating to antennas, piezoelectric signaling, circuit switching, or manipulation of such digital data. This digital data may be associated with system inputs from sensors, instrumentation, keypad, or digital processor; or structured as digital text, digital codes, digital images (static or video), digitalized audio, or digital representations of biometric data. Such digital medium may be represented as encrypted, compressed, encapsulated, embedded; or contained within digital software programs, object code, or digital watermarks; in which case the entire representation is considered as “digital medium”.

### DETAILED DESCRIPTION

This invention provides a system with several unique methodologies that use steganography to embed a hidden knowledge base of behaviors within digital content that, upon extraction, will control its security and govern the content's use by end-users; without network interaction or enforcement. The system creates unalterable embedding that assures all embedded data, such as but not limited to, behaviors, controls, and validation are not altered nor duplicated for the specific medium content it is created for. The intent herein is not strictly to hide, data but to incorporate elements to control use which includes source and user validations.

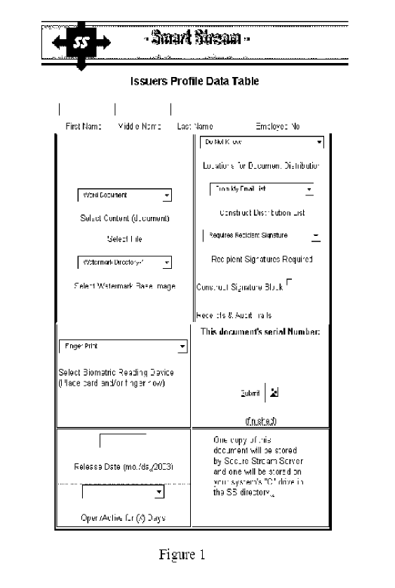

The system directs a formal procedure to create a secure knowledge base that governs structuring behaviors, controls, and conditions of use by the medium itself. Steps, in this formal procedure gathers, formats, and otherwise structures data, from inputs the author deems pertinent for recipient users. FIG. 1 shows a typical menu driven interface for this process.

These behaviors include, but are not limited to, who is allowed access to the digital medium; what in the digital medium the receiving party has access to; when the digital medium becomes available, or is destroyed; where the digital medium may be received (The recipient must be at a specific network addresses or geopositioning coordinates); and, how the digital medium is used (can it be copied, stored, modified, electronically signed, or archived). The extraction and process execution of these embedded behaviors are initiated when the receiving party enters the digital medium's identifier(s) into the extraction execution module. Medium identifiers may be, but are not limited to, serial numbers, date and time, or other types of identifiers. The embedded affirmation of the receiving party is based upon authentication procedures that can be customized for applications and may include the user's profile data consisting of biometrics, raw data, encrypted data, digital certificate, digital signature, or other forms of acceptable user authentication. The selection of the recipient's authentication data is architect to be consistent with the behavior authoring routine.

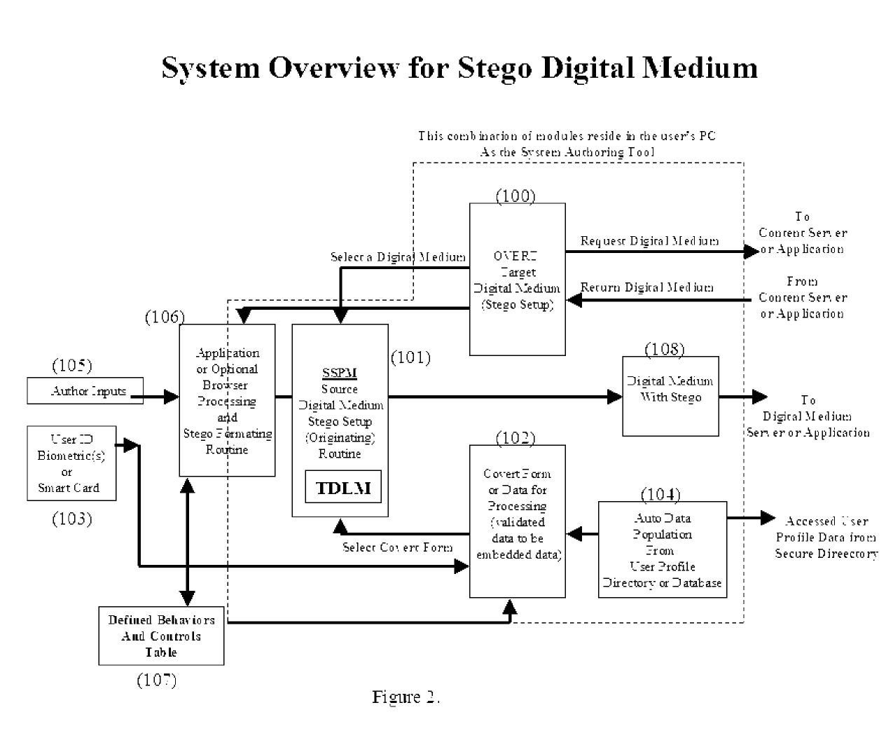

Application interfaces and use modes are part of this invention and include, but are not limited to, web-based content with steganographic behaviors and controls; smart card series that use steganogrpahic validation of the cardholder; audio files with steganographic behaviors and controls; and, multimedia files that have steganographic behaviors and controls. With each application there exist authoring and extraction routine based upon similar process flows as shown in FIG. 2.

Using the process shown in FIG. 2, the steganography authoring procedure allows the author to select the medium file that will be used as the overt content (100). This content is accessed via a content server or from a local file. If this content contains an identifier, such as a form or serial number, the Overt Processing Module (100) will validate it using a dual MAC (message authentication code). Setting up this validation process assures that any of the mediums content templates or form is the latest version to work from. This is done using standard MACs and encryption processes. The last function for this module, before transferring to the next processing module, is to automatically construct data placement overlay that will contain the contents new serial number (identifier), time stamp, and primary and secondary MACs. Once this placement overlay(s) is calculated; the resulting data will appear in the overt content as readable data (usually placed in margins or headers).

The second step is to acquire and structure data to be embedded into the overt digital medium using the Covert Forms Module or CFM (102). The acquired covert data consist of three types; data used to validate the author such as a profile and/or biometrics data; data selected by the author to identify and validate end user(s); and, data used to define behaviors and controls to be applied to the overt content. The author's validating information may access several different sources and may include keyboard and biometric scanner(s) (103) inputs, the author's profile extracted (if encrypted it remains encrypted) from a secure directory (104); and/or smart card extracted validation data (103).

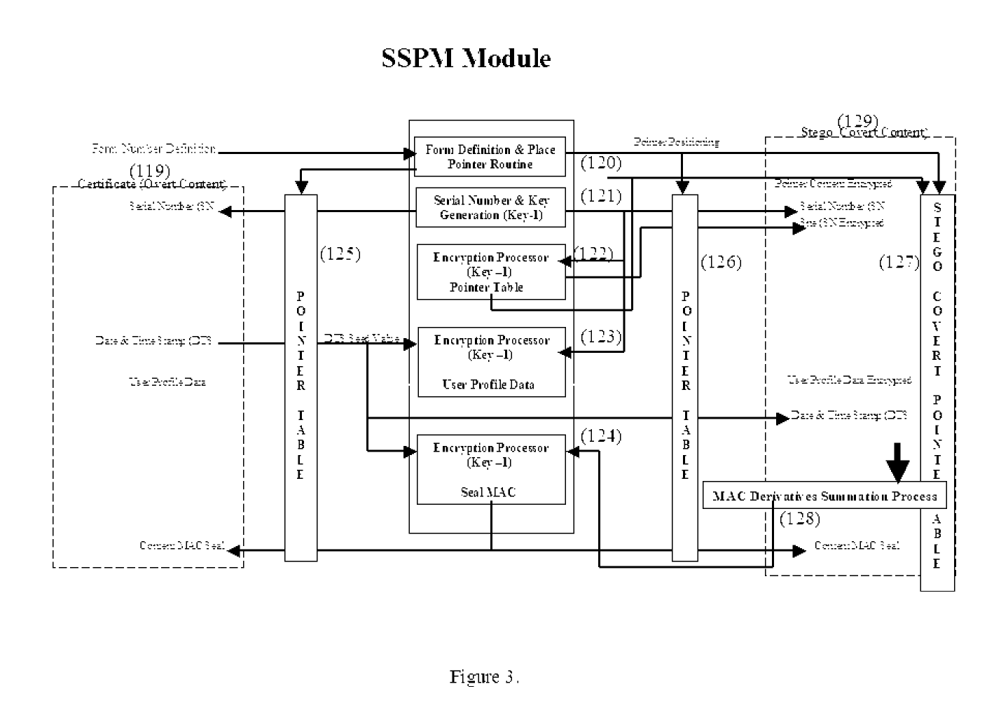

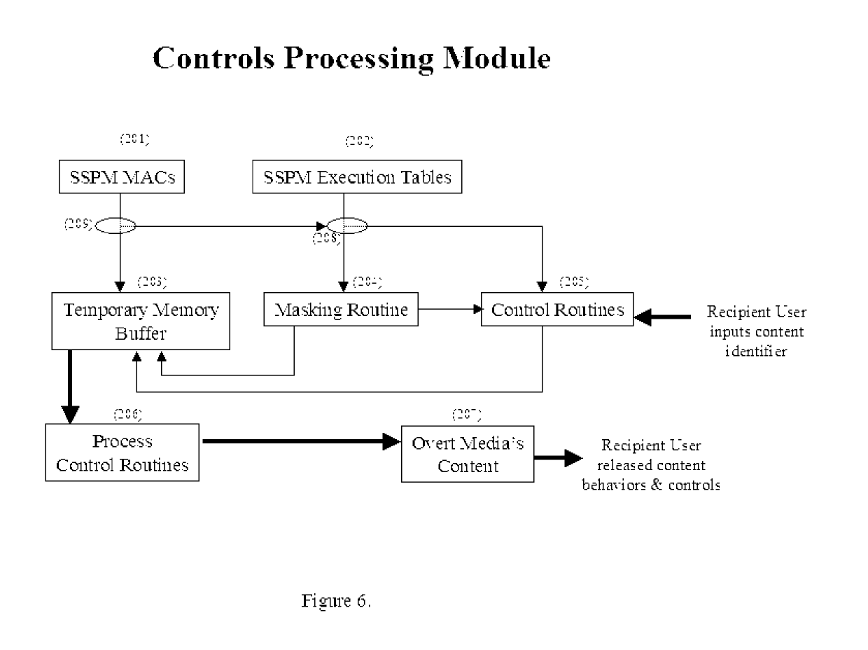

In the authoring process, end user profile data are provided to validate identified user(s). The data is not provided in clear text form but is encrypted and associated with the user's identifier (such as employee number or other identifiers) and combined with a time stamp for use by the Controls Processing Module (FIG. 6, Item 202). If no end user is identified, the system behaviors and controls will execute when prompted by any receiving user who inputs the medium's identifier into the execution module's menu prompt. User profile data is not limited to, but includes, digital certificates, encrypted personal data, digital photograph, and/or smart card data. The system may use encrypted data as a value; or it may be set up to incorporate user's seed values; or encryption key in the SSPM processing. All personal data is structured by the Covert Form Populating Module, or CFPM) (104) and formatted for the SSPM (101) tables. Behaviors and controls are predefined and formatted as table data (107) and stored in a file accessed by the Covert Data Processing Module (102). The system stego processing module, or SSPM (101), dynamically constructs and breaks down the logic driven pointer tables; illustrated in FIG. 3. These tables are structured to array the bit structure in order to build a higher level of security in the steganographic algorithms.

The SSPM uses two file folders to work from, one contains the medium's Overt Data or content (119) and the other contains the behaviors, controls, and authentication data or Covert Data (129), that is structured using the System's schema (sets up a template of the data and defines rules). The System's schema defines enterprise-authoring elements for each medium. The schema is medium dependant.

The SSPM consist of a table driven steganography algorithm for process creation and deciphering; an encryption processing algorithm, and the Table Driven Logic Module (TDLM); as shown in FIG. 3.

This data is structured using predefined Pointer Tables (125) for each type of medium (119) such as text, audio, video, or multimedia. In addition, the Form Definition & Placement Pointer Routines (120) defines the format and coordinate locations for hidden data in the covert content; again this is structured in the Pointer Table (125) for specific medium content. The Stego Pointer Tables (127) are always located in the same coordinates of the covert data and the contents of the table are encrypted using the medium's content identity code plus its seed value (time stamp).

The Serial Number & Key Generation module (121) takes the existing, or new serial number, and uses it as the encryption key to generate the Session Key (Key 1) that incorporates the time stamp data as the seed value. The resulting value is placed in the mediums overt content in the form of an overlay while the same serial number appear in the defined Pointer Table (126) and “arrayed” into the covert content in the Stego Covert Pointer Table (127). The “array” Stego Covert Pointer Table data is processed for a check sum and that sum is encrypted with Key 1 (K-1) as the derived Message Authentication Code (MAC.) (128). This MAC in placed in the overt content overlay and bound using the contents new serial number, resulting in the medium's Content Seal.

Both the Pointer Table and the end user profile data are encrypted (using the K-1 encryption key) using Encryption Processor Pointer Table module (122) and the Encryption Processor for User Profiles (123). Both resulting values are placed in the Pointer Positioning Table for array distribution (126) and copied to the Stego Covert Pointer Table (127). The Pointer Positioning Table (126) is created for the process and then destroyed. The System provides a one-way creation from this module and recreates it in the extraction process for the purpose of locating the data within the covert content (129).

Encryption Processor for TDLM FIG. 3 (FIG. 2, part of item 101). The Form Definition & Placement Pointer (120) is the first module used to deciphered data from the covert content. The covert content contains encrypted table data that is deciphered using the content's identity (such as a serial number) as the decipher key. Once the Pointer Tables are deciphered, all remaining covert data (encrypted) can be retrieved and deciphered using the date and time stamp as seed value along with the medium's content identity (serial number key as Key-1).

Serial Number & Key Generation (121). The Serial Number is encrypted and stored both in plain text and cipher text form as a location for converted content and is located by the content's Pointer Table.

Encryption Processor User Profile Data (123). The User Profile Data (consisting of encrypted values such as a user's biometrics, smart card data, and PIN numbers or any other data relating to the User). The User's profile data never appears in the clear but is stored as ciphered data. The encrypted value is unique to the medium's content since it is seeded with the date and time stamp value.

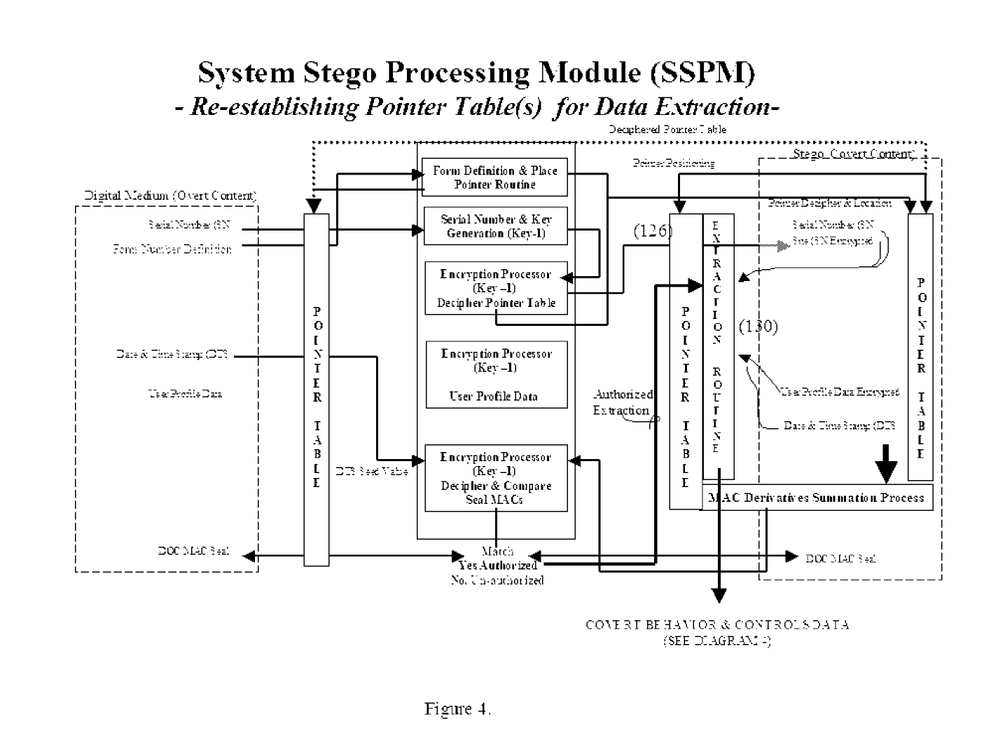

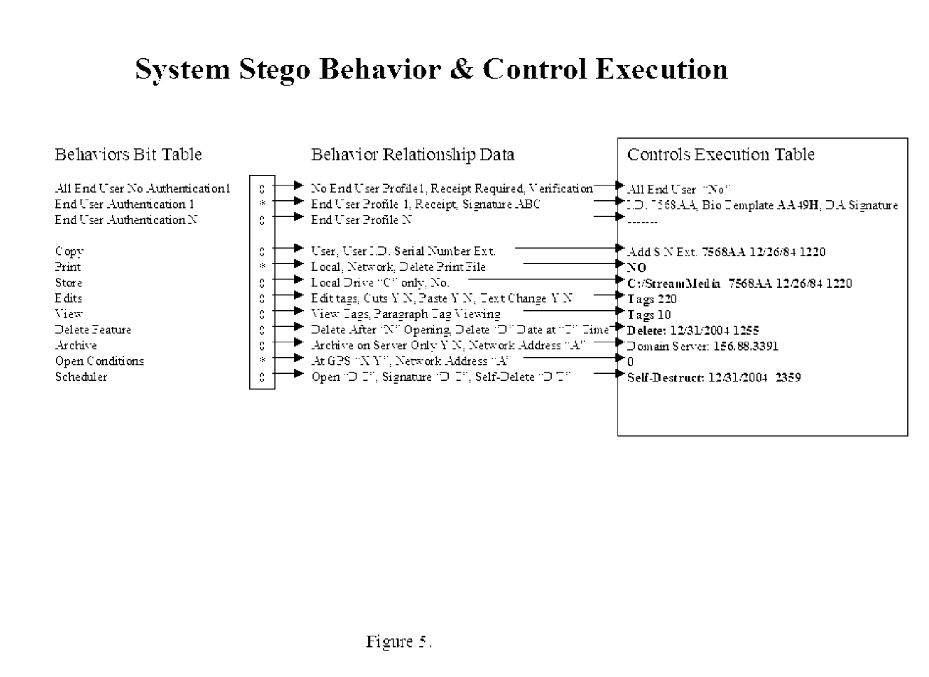

Encryption Process Seal Message Authentication Code-Seal MAC (128). The Seal MAC is the code that will verify that the covert data is the data to be used by the steganographic behaviors and controls. The Seal MAC also authenticates whether the content is authorized or not. Here we use the derivatives of the summation in order to calculate the MAC, but it can be done also with the Check Sum Process. This assures that the object variables (behaviors and controls) themselves have not been altered and that the original form used to generate the content (template, form etc.) was an authorized version. The Seal MAC of the Covert data is compared to the Overt Seal Mac; if the two MACs are the same, then the covert data is correct and the content is authenticated as an original, unaltered, with the author's signature. System Steganography Processing Module (SSPM) Re-establishing the Pointer Tables and Extraction Routine. (FIG. 3). FIG. 4 shows the rebuilding of the Pointer Table (126) using the same process as described for medium's steganographic authoring process (FIG. 3). The difference here is that the reconstruction of the pointer table provides input to the Extraction Routine (130). The Extraction Routine (FIG. 5) gathers the covert behaviors, controls data, and end-user authentication, if any, are passed to the Behavior and Control Processing Module (FIG. 6) for execution.

The Controls Processing Module (CPM), FIG. 6, is like a content viewer and resides in the receiving party's system or may optionally be accessed via a web server. CPM executes all behaviors and controls over the media's content. In order to prevent bogus table data from being entered into the CPM the controls are masked against the content's tables and seal Message Authentication Codes (201 and 202) in a queuing buffer setup in CASH or temporary memory buffer (208). This serves two purposes. First, it assures that the control elements have not been altered and second, it sets up a controls audit receipt that shows what controls the receiving party executed. This receipt may optionally be returned to the content's author or source. This is especially useful in using this invention in email, instant messaging, and document handling applications.

The control's masking (204) is a bit table that calls behavior and control routines to execute specific actions on the content. These routines are modified by steganographic data each time they are called upon to execute. To accomplished this we segment the SSPM MAC and SSPM Execution Table data and combined the results with a time stamp and use this results as a Session Identifier (208 and 209). These Session Identifiers are used to modify the Control Routines (205) when processed (206). The modifications are made to assure that the routines have not been modified and that the user, or application, identifiers are correct for execution. If the identifiers are not correctly matched, no action is taken and access to that control item is blocked.

The Recipient User inputs the content's identifier, such as its serial number, into the Controls Routine (205). The Control Routines request the Execution Tables and MACs from the SSPM (201 and 202). Segmentation of these data elements, plus time stamps, are made by (209 and 208) which is fed back to the Controls Routine as temporary session identifiers. In addition, the table data is moved to the Masking Routine (204) which selects routines to be executed by the Control Routines (205). Both the Masking Routine (204) data and Control Routines (205) are transferred to the Temporary Memory Buffer (203) along with the session identifiers. This data is processed by the Process Control Routine (206) and dictates action placed on the Overt Media's Content (207) that releases controlled content to the Recipient User.

In FIG. 2, the author input is via a keyboard (105) to the application (106) and the steganographic modified digital medium is (108); which is sent back to the application or held as a file.

When applying this invention to multimedia, one additional feature is added that allows single streamed digital content to self-edit depending upon the receiving parties' preference profiles. Unique to this invention is that the receiving parties' preference profiles do not reside on a network database but inside the parties' computer or digital device.

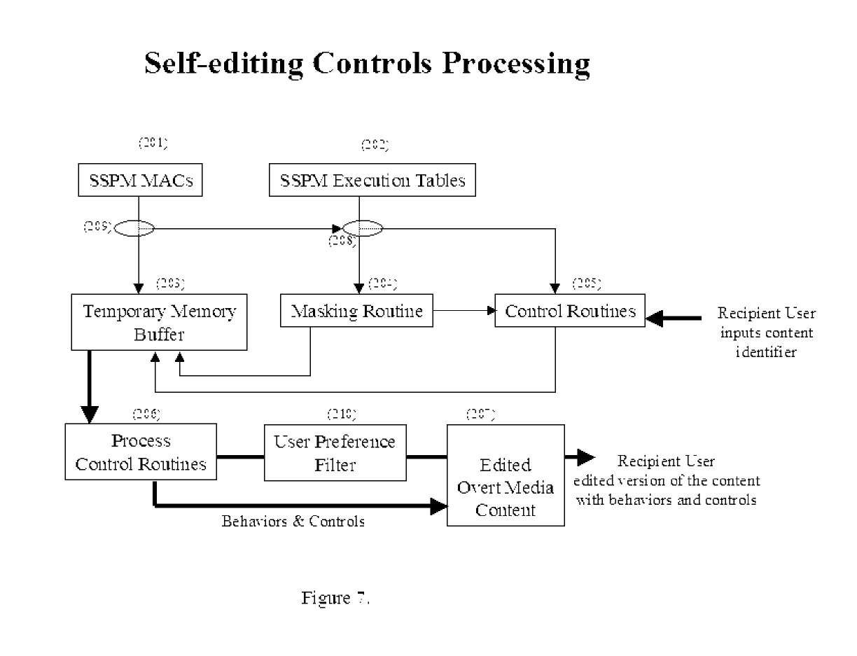

Multimedia authoring process requires that the hidden embedded behaviors include Meta tags that tag general content for text, video, and audio. In addition, the editing tags also set up a synchronization bit headers and a set of editing categories that are setup in steganographic masking table in the header. The header embedded behavior guides (masking table) comply with the receiving party's preferences and automatically establish the rules of edit based upon the construction of a schema dictionary that is menu driven as part of the setup routine for the viewing parties. This dictionary schema matches a bit pattern that is part of the streamed media's tag tables that is addressed as bit patterns and setup in local memory as indirect addressing of schema table locations. FIG. 7 shows this process. The synchronization of the audio to the video is based upon multiple digital signals frequencies on a single base carrier signal and the behaviors auto-select which frequency to used based upon the viewer's preferences. This allows multiple languages to be streamed within a single stream of video.

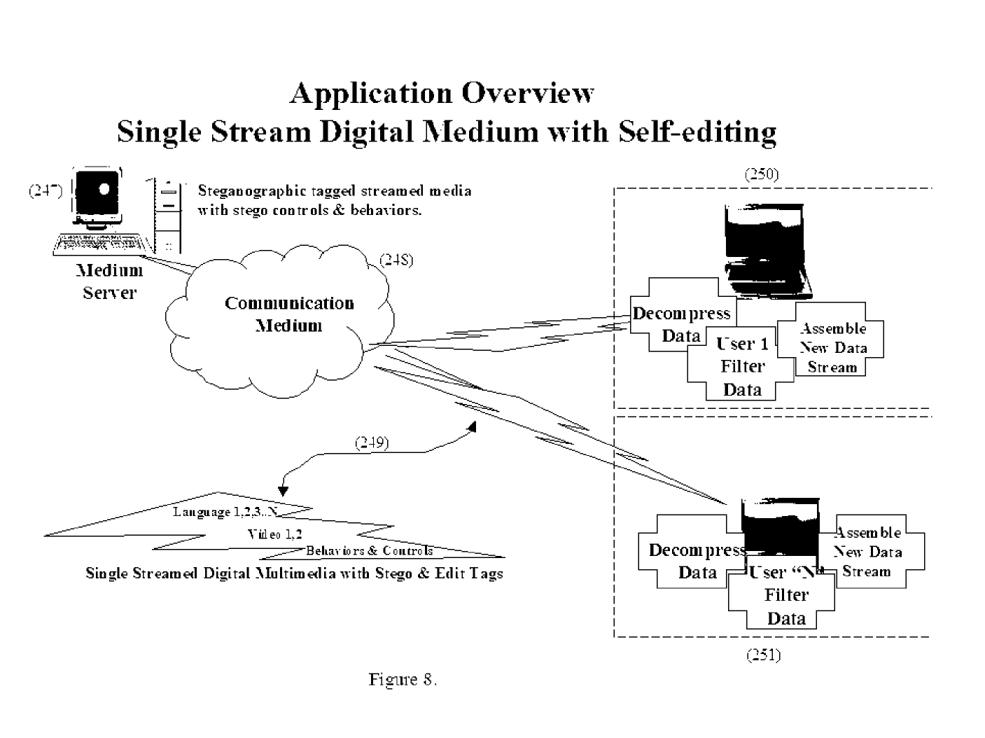

FIG. 8 shows the operationally system structure steganographically controlled multimedia (smart media). The content multimedia stream is authored with editing tags, compressed and sent as a broadcast to all viewers or receiving parties. Upon decompression, the header is processed setting up the rules for edit of text, audio, and video. The synchronization bits align the text and audio with the video frames

What is claimed is:

1. A system and methodologies for hiding embedded knowledge base into content in a manner that results in content-centric controls and behaviors over the medium itself.

2. This invention uses covert knowledge base within content to control content-centric financial instruments over networks. These financial instruments may be, but are not limited to, credit/debit network vouchers (cardless transaction mediums), network-based letters of credit that can be drawn upon from one or more clients, and network-based gift certificates. The steganographic financial medium of this inventions allows a single, one-of-a-kind content, that is assigned to a single or group of users, to exist on a network in a manner allowing value to be added and deducted; while capturing the voucher's transactions audit trail. User authentication takes place as a verification of user profile data with the steganographic (cover) content.

3. This invention has a steganographic methodology for hiding embedded biometrics and user profile data, as covert data, within digital photographic image for the purpose of creating a, one-of-a-kind, bit map capture of multiple characteristics of the user (such as multiple biometrics data). This verifies the cardholder's characteristics held within his or her digital photograph allowing the digital photograph to authenticate the cardholder and at the same time the card holder be authenticated to the contents hidden within the photograph. The one-way creation and extraction process of claim 3 used in identification and access control permissions authenticate cardholder to the card, as a token, without network interaction of centralized verifications.

4. The knowledge based controls of claim 1 has the means to control the content's use by defining who the end user may be and grants the user access to interact with a portion, or all, of the overt content; and how that content may be used.

5. The knowledge base control of claim 1 has the means of controlling where the content may be accessed or interacted with. The location of “where” may be a network address and/or geopositioning coordinates.

6. The knowledge base of claim 1 has the means of dynamically changing end-user trust levels. The steganographic process allows the authoring source to determine the trust level of content's receiving parties. Multiple end-users with different trust levels may have access to different portions of the content at the same time. Trust levels of end users are part of the authoring process of the covert knowledge based controls.

7. The knowledge base controls of claim 1 has the means of determining the time frame in which content may be accessed, interacted with, destroyed, or archived.

8. The knowledge base controls of claim 1 use its steganographic methodologies to authenticating both the source and its end-users.

9. The hiding, embedding, extracting, and execute the behaviors of claim 1 includes a means of creating an electronic steganographic notary as a behavior of the digital medium's content. The Steganographic electronic notary can be a signed covert document that is imbedded inside the overt content. The table driven steganographic architecture provides a means for a witness to digitally sign a witness statement and also allow them to apply the embedding of the witness' biometric data.

10. The process of claim 1 includes one or more prior art forms, but is not limited to, digital signatures, digital certificates, digital biometric data, and digital profile data; as identified in the authorship of the digital medium's governance. It also include prior art in cryptographic, steganographic, and authentication methodologies.

11. The process of claim 1 includes hiding and embedding encryption, authentication, encryption keys, seed values, electronic tokens, and other security techniques in content for the purposes of using that content as a carrier for the purpose of setting up secure session transmission (wire and wireless) applications and authenticating network boarder servers and devices. Also, the carrier transmits keys to authenticating remote devices and users. Such key exchanges serve the purposes of authentication the device receiving the digital medium; authenticate wireless device involved in the transmission or receipt of the digital medium; authenticate remote users associated with the digital medium; and establish a one-time session key for encrypted transfer of the digital medium to. These hidden key exchanges may also establish dynamic digital filtering for reading remote devices such as, but not limited to, radio frequency identification (RFID) tags, digital transponders, sensors, and piezoelectric signals (also includes sensor based steganographic technologies under development by the Inventor herein). The system derived digital medium behaviors do not rely upon network-centric controls, or object link embedding, for their extraction and execution; once the behaviors have been authored and embedded into the digital medium.

12. The hidden embedding of self-governance of claim 1 allows content to contain transactional security without network governance.

13. The structuring of covert bit structures resulting from the table driven steganographic process in claim 1 assures original, one-of-a-kind digital content for digital medium, which self-governs its use and security. This is done accomplished by the following: by requiring receiving parties extraction and execution to reconstruct tables that locate behaviors and controls within a bit array architecture; by using multiple message authentication codes (MACs) to validate logic table structures using user(s) profile data (encrypted) and content behaviors, content identifiers, seed variables, and timestamp(s); and by providing a means of changing, receiving party's trust levels for specific content and thereby assuring that only that party is able to read or interact with the content.

14. The process and bit array structuring of table driven logic inside steganographic process relative to claim 1 assurances a virus-free digital medium due to multiple interlocking message authentication codes (MACs) established between logic tables, behaviors, and their bit array patterns established during the steganographic process that includes the following: a) Content has automatic resistance to embedded viruses object codes through table driven bit map(s) for digital medium verifications; b) Content is in tamper resistance digital medium do to the random sample bit-arrays created through this invention's table driven steganography architecture;
and assurances that the content is original, one-of-a-kind for its digital medium, and which self-governs its use and security.

15. This image and biometric steganographic of claim 3 is applied to chip-based cards, smart cards, and identification tokens such that the user (cardholder) is authenticated to the card device without the need for network connections using this invention's authoring and extracting process.

16. As pertaining to claim 3 and Subclaim 15; this invention using covert steganographic capture of user biometrics and profile data also captures the identification, biometrics, or profile data of the card issuer or issuing agent's identifications as a signature hidden within the digital photographic/image content. This allows not only the authentication of the cardholder but also the identification of the issuing agent for the card to be captured upon extraction of the covert data.
